(19) United States
(12) Patent Application Publication
(10) Pub. No.: US 2017/0257299 A1
(43) Pub. Date: Sep. 7, 2017

(54) PACKET ANALYSIS APPARATUS, PACKET ANALYSIS METHOD, AND COMPUTER READABLE STORAGE MEDIUM

(71) Applicant: FUJITSU LIMITED, Kawasaki-shi (JP)

(72) Inventor: Fumiyuki Iizuka, Kawasaki (JP)

(73) Assignee: FUJITSU LIMITED, Kawasaki-shi (JP)

(21) Appl. No.: 15/448,905

(22) Filed: Mar. 3, 2017

(30) Foreign Application Priority Data
Mar. 7, 2016 (JP) 2016-043903

(51) Int. Cl. H04L 12/26; H04L 1/16; H04L 29/06

(52) U.S. Cl. CPC H04L 43/0835; H04L 69/22; H04L 43/0852; H04L 1/1614

(57) ABSTRACT

An apparatus including: a memory, and a processor coupled to the memory and the processor configure to: monitor packets received from a communication apparatus and packets transmitted from the communication apparatus, and make a determination that a packet is lost in the communication apparatus by detecting that the packet is received by the communication apparatus within a first time period and not transmitted from the communication apparatus within a second time period, an end of the second time period being set to later in time than an end of the first time period.

### CROSS-REFERENCE TO RELATED APPLICATION

This application is based upon and claims the benefit of priority of the prior Japanese Patent Application No. 2016-043903, filed on Mar. 7, 2016, the entire contents of which are incorporated herein by reference.

### FIELD

The present embodiments relate to a packet analysis apparatus, a packet analysis method, and a compute readable storage medium.

### BACKGROUND

There is a method which acquires and analyzes a packet flowing to a monitoring target apparatus in a network. Further, there is a technology which detects a packet lost in a monitoring target apparatus. As a related art, there is a technology by which, after a representative node receives a multicast data packet, a value indicating whether reception of a data packet results in success is recorded into a bitmap field and it is decided from the bitmap whether data packet loss has occurred (for example, refer to Japanese Laid-open Patent Publication No. 2009-207147). Further, there is a technology by which, when a plurality of kinds of test packets are transmitted to and received from a test target apparatus and the transmission and the reception end, any kind of test packets with regard to which the count value of the number of received test packets is lower than the count value of the number of transmitted test packets is specified as the kind of discarded packets (for example, refer to Japanese Laid-open Patent Publication No. 2008-42410). Furthermore, there is a technology by which an identifier corresponding to an address of a packet in the current cycle is searched for from within a storage unit in which an identifier of a packet in the preceding cycle is retained in an associated relationship with an address of a transmission source or a transmission destination, and when the identifier of the packet in the current cycle is smaller than the identifier of the packet in the preceding cycle, it is decided that order reversal has occurred (for example, refer to Japanese Laid-open Patent Publication No. 2009-182430).

### SUMMARY

According to an aspect of the embodiments, an apparatus includes a memory, and a processor coupled to the memory and the processor configure to: monitor packets received from a communication apparatus and packets transmitted from the communication apparatus, and make a determination that a packet is lost in the communication apparatus by detecting that the packet is received by the communication apparatus within a first time period and not transmitted from the communication apparatus within a second time period, an end of the second time period being set to later in time than an end of the first time period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating an example of operation for a packet verification apparatus according to an embodiment;

FIG. 2 is an explanatory view illustrating an example of a configuration of an information processing system;

FIG. 3 is an explanatory view illustrating an example of a hardware configuration of a packet verification apparatus;

FIG. 4 is an explanatory view illustrating an example of a functional configuration of a packet verification apparatus;

FIG. 5 is an explanatory view illustrating an example of storage substance of a session table;

FIG. 6 is an explanatory view illustrating an example of storage substance of management bit information;

FIG. 7 is an explanatory view illustrating an example of operation for packet loss decision in a working example 1;

FIG. 8 is a flow chart illustrating procedure for a packet analysis process on a reception side in the working example 1;

FIG. 9 is a flow chart illustrating procedure for a packet analysis process on a transmission side in the working example 1;

FIG. 10 is a flow chart illustrating procedure for a packet loss decision process in the working example 1;

FIG. 11 is a flow chart illustrating procedure for a decision target session packet loss decision process in the working example 1;

FIG. 12 is an explanatory view illustrating an example of operation for packet loss decision in a working example 2;

FIG. 13 is a flow chart illustrating procedure for a decision target session packet loss decision process in the working example 2;

FIG. 14 is an explanatory view (part 1) illustrating an example of operation for packet loss decision in a working example 3;

FIG. 15 is an explanatory view (part 2) illustrating an example of operation for packet loss decision in the working example 3;

FIG. 16 is a flow chart illustrating procedure for a packet analysis process on a reception side in the working example 3;

FIG. 17 is a flow chart illustrating procedure for a reception side IPID (IPID: identifier (ID) of internet protocol (IP) header) recording process;

FIG. 18 is a flow chart illustrating procedure for a packet analysis process on a transmission side in the working example 3;

FIG. 19 is a flow chart illustrating procedure for a transmission side IPID recording process;

FIGS. 20A and 20B are flow charts illustrating procedure for a decision target session packet loss decision process in the working example 3; and

FIG. 21 is an explanatory view illustrating an example of outputting of a packet loss decision process.

### DESCRIPTION OF EMBODIMENTS

However, there are some cases where fails in decision of lost packets occur. For example, if respective bit sequences corresponding to respective identification information of received packets and transmitted packets within a certain period of time are compared with each other, a packet that is received within a certain period of time and transmitted within a next period of time continuing from the certain period of time is decided as a lost packet although it is not actually lost.

According to one aspect, it is an object of the present embodiment to provide a packet verification program, a packet verification apparatus, and a packet verification method that may improve the accuracy in decision of lost packets.

In the following, the embodiments of the disclosed packet verification program, packet verification apparatus, and packet verification method are described in detail with reference to the drawings.

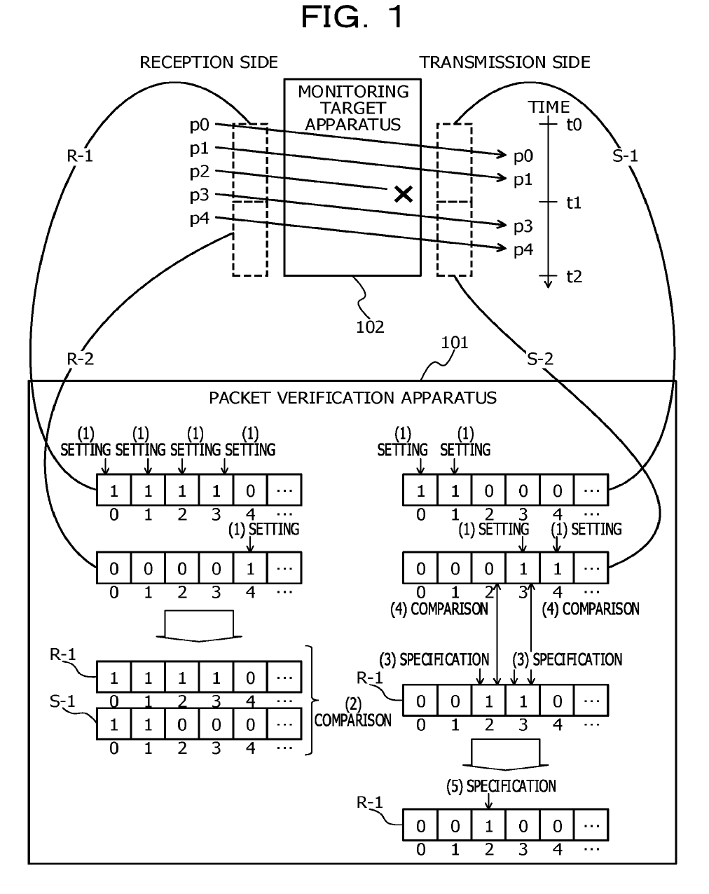

FIG. 1 is an explanatory view illustrating an example of operation for a packet verification apparatus according to an embodiment. A packet verification apparatus 101 is a computer that verifies a packet lost in a monitoring target apparatus 102. Here, the packet signifies data transferred in a communication network. Further, that a packet is lost is hereinafter referred to as “packet loss.” For example, if packets flowing in the network increase, packet loss sometimes occurs. Then, if packet loss occurs, the lost packet is re-sent, and therefore, a vicious cycle that packets flowing in the network further increases sometimes arises.

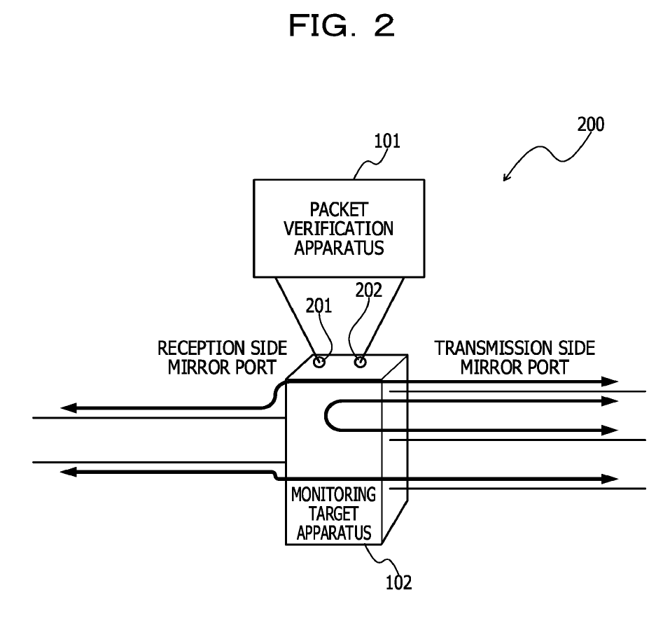

Here, it is assumed that a packet in the present embodiment includes an IP header that is a protocol of the network layer. The packet in the present embodiment may be transmitted by any of wire transmission and wireless transmission only if it includes an IP header. The packet verification apparatus 101 acquires and analyzes a packet transferred by the monitoring target apparatus 102 and acquires the IP header included in the packet. In what manner the packet verification apparatus 101 acquires a packet transferred by the monitoring target apparatus 102 is described with reference to FIG. 2. Also a particular example of the monitoring target apparatus 102 is described with reference to FIG. 2. The IP header includes a transmission destination IP address, a transmission source IP address, a protocol number and so forth.

Further, the packet includes a header of a protocol of the transport layer according to the protocol number included in the IP header. As the protocol of the transport layer, there are transmission control protocol (TCP), user datagram protocol (UDP) and so forth. The packet verification apparatus 101 analyzes a protocol of the transport layer from the IP header included in a packet and acquires a TCP header or a UDP header according to a protocol number included in the IP header. The TCP header or the UDP header includes a transmission source port number, a transmission destination port number and so forth.

As one of reasons for a vicious cycle that packets flowing in the network further increase, in the case of TCP, a function is provided that, if loss of a packet is detected, the packet is re-sent. This function further increases packets flowing in the network. Also in the case of UDP, if application software higher than UDP has a function for re-sending a lost packet, packets flowing in the network further increase similarly as in the case of TCP.

Here, since the packet has a transmission source port number and a transmission destination port number specified for each session, there is a demand to grasp a packet loss generation situation for each session. The session is specified by a combination of a transmission destination IP address, a transmission source IP address, a protocol number, a transmission source port number, and a transmission destination port number. If a packet loss generation situation is found in a unit of a session, the reception port and the transmission port of the monitoring target apparatus 102 may be specified, and also a communication situation of a different session that uses a same transmission port or a manner of loss may be found.

For example, as a method for grasping a packet loss generation situation for each session, it seems promising to compare the total number of reception packets and the total number of transmission packets after a session starts until the session ends. However, in this case, it is difficult to grasp a generation situation of packet loss until the session ends.

Further, it seems promising to store transmission and reception situations for each piece of identification information (ID) included in the IP header of a packet to specify packet loss. For example, packets are stored as they are or a fixed number of hash values obtained by hash processing of the header part of the packets or the entire packets are stored, and matching of the packets or the hash values is performed between the reception side and the transmission side to specify packet loss. However, this is not realistic because the load on a central processing unit (CPU) or the load on a memory increases.

For example, it is assumed that it is tried to specify packet loss at a communication rate of approximately 100 gigabits per second (Gbps). In this case, the communication rate corresponds to approximately 100,000,000 packets per second (pps). Then, the interval after which transmission and reception situations are to be stored is one millisecond. Accordingly, 100,000 packets are processed in one millisecond. When matching is performed for all of 100,000 packets, the load on the CPU is high. For example, it is assumed that matching of respective packets is performed by a loop of the for syntax and ten clocks are used for one cycle of matching. In this case, in order to perform matching of one packet with other 100,000 packets, one mega clocks are used. Then, for example, a CPU having a clock frequency of 3 GHz may process only approximately 3,000 packets. Further, if storage of packets and IPIDs is managed using a list, a further increased number of clocks are consumed. However, if a list is not used and a sufficient storage area is secured in advance, a huge amount of memory is consumed.

As a method for suppressing the memory consumption amount, it seems promising to generate a bit sequence in which a bit is allocated to each value that may be assumed by the ID of the IP header of the packet and set, in response to transmission or reception of a packet, the corresponding bit as valid or invalid to detect packet loss. The ID of the IP header is hereinafter referred to as “IPID.” Further, to set a bit as valid may be to set the bit to “1” or may be to set the bit to “0.” In the description given below, to set a bit as valid is to set the bit to “1,” and to set a bit as invalid is to set the bit to “0.”

However, a decision of packet loss of a bit sequence within a certain period sometimes fails to decide correctly. For example, if a bit sequence is generated at intervals of one millisecond, it is decided that a packet received within a period of 0th to 1st millisecond and transmitted within a period of 1st to 2nd millisecond is lost in the bit sequence described above.

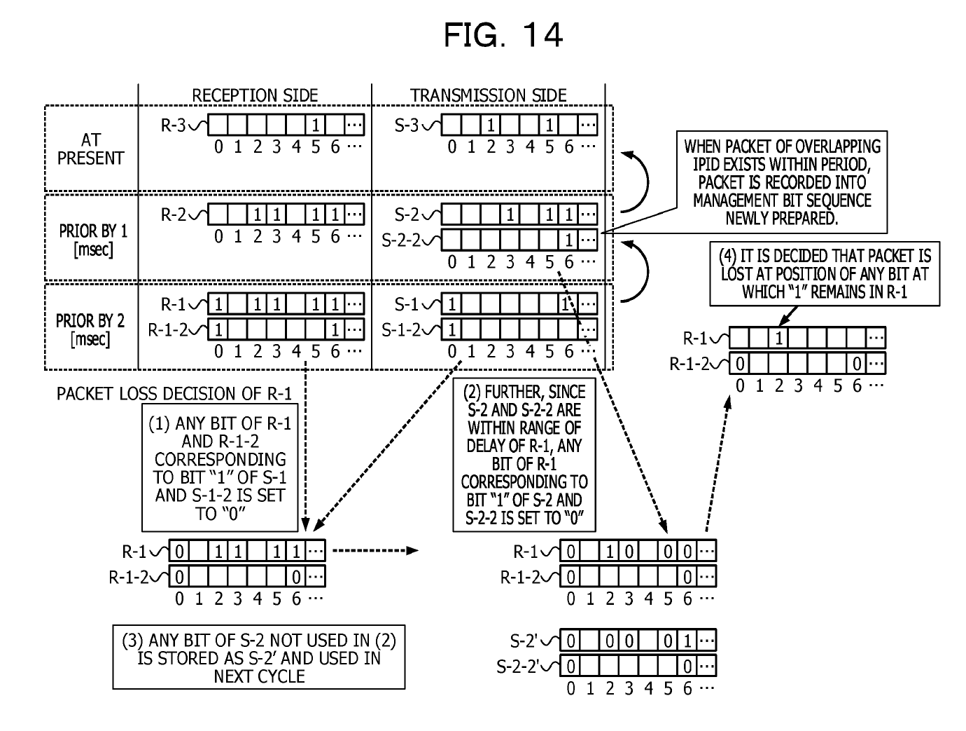

Therefore, it is described that, in the present embodiment, any bit of a packet transmitted within a period, from within a bit sequence in which a bit corresponding to a packet received within the same period is set to “1,” is set to “0” while any bit of a packet transmitted within a next period from among the remaining bits is set to “0.” Here, the IPID may increase sequentially or may increase at random for each session or for each terminal. FIGS. 1 to 13 are directed to the case in which the IPID increases sequentially. The case in which the IPID varies at random is described with reference to FIGS. 14 to 20.

An example of operation for the packet verification apparatus 101 is described with reference to FIG. 1. In the example of FIG. 1, it is assumed that the monitoring target apparatus 102 receives packets p0 to p4 and transmits the packets p0, p1, p3, and p4 while it loses the packet p2. Further, the monitoring target apparatus 102 receives the packets p0 to p3 and transmits the packets p0 and p1 within a period from time t0 to time t1 as a first period. Meanwhile, the monitoring target apparatus 102 receives the packet p4 and transmits the packets p3 and p4 within another period from time t1 to time t2 as a second period. As depicted in FIG. 1, since delay occurs in the monitoring target apparatus 102 between the reception side and the transmission side of the monitoring target apparatus 102, even if packets on the reception side and the transmission side within the same period are compared with each other, correct decision may not be made. It is described that, in the example of FIG. 1, the packet verification apparatus 101 may decide correctly that the packet p3 that spans the first period and the second period is not lost and that the packet p2 is lost.

As indicated by (1) in FIG. 1, the packet verification apparatus 101 sets, from among respective bits, those bits corresponding to a received or transmitted packet to “1.” Here, each bit corresponds to a combination of the IPID of the packet, a period including a point of time at which the packet is received or transmitted and a type indicating transmission or reception of the packet. For example, in FIG. 1, the respective bits are all bits of R-1, R-2, S-1, and S-2. For example, the R-1 is a bit sequence corresponding to a packet received by the monitoring target apparatus 102 within the first period. Similarly, the R-2 is a bit sequence corresponding to a packet received by the monitoring target apparatus 102 within the second period. Further, the S-1 is a bit sequence corresponding to a packet transmitted from the monitoring target apparatus 102 within the first period. Similarly, the S-2 is a bit sequence corresponding to a packet transmitted from the monitoring target apparatus 102 within the second period.

Here, the first period and the second period may be periods of a substantially equal interval or may be periods of different intervals. However, in order to facilitate management, the first and second periods preferably have a substantially equal interval. In the present embodiment, the first period and the second period have a substantially equal interval, and a period having the interval described above is referred to as “use period.” The use period is, for example, one millisecond.

In the description given below, a bit sequence corresponding to received or transmitted packets is hereinafter referred to as “management bit sequence.” Further, a management bit sequence corresponding to received packets is referred to as “management bit sequence on the reception side.” Similarly, a management bit sequence corresponding to transmitted packets is referred to as “management bit sequence on the transmission side.” Further, in a representation of a management bit sequence, the management bit sequence [x] indicates the xth bit from the top of the management bit sequence. Further, in FIG. 1, the management bit sequence [x] corresponds to the IPID of a packet px for simplified illustration.

In the example of FIG. 1, the packet verification apparatus 101 sets the management bit sequences R-1 [0] to [3], S-1 [0] and [1], R-2 [4], and S-2 [3] and [4] to “1.”

Then, the packet verification apparatus 101 compares the management bit sequence R-1 and the management bit sequence S-1 with each other as indicated by (2) of FIG. 1. Since it may be recognized that the comparison reveals that the packets p0 and p1 corresponding to the bits of “1” in both of the management bit sequences R-1 and S-1 are transmitted within the first period, the packet verification apparatus 101 sets the management bit sequence R-1 [0] and [1] to “0.” Then, as indicated by (3) in FIG. 1, the packet verification apparatus 101 specifies, based on the result of the comparison, a first packet group that is received within the first period, besides is not transmitted within the first period. In the example of FIG. 1, the packet verification apparatus 101 specifies the IPIDs of the packets p2 and p3 corresponding to the management bit sequence R-1 [2] and [3] at which “1” remains as the respective IPIDs of the first packet group.

The first packet group includes a lost packet or packets and a packet or packets transmitted within the second period continuing from the first period. Therefore, as indicated by (4) and (5) in FIG. 1, the packet verification apparatus 101 specifies the respective IPIDs of a second packet group based on the respective IPIDs of the first packet group and also on the management bit sequence S-2. The second packet group is a packet group that is received within the first period and besides is not transmitted within any of the first period and the second period.

In the example of FIG. 1, the packet verification apparatus 101 compares, as indicated by (4) in FIG. 1, the management bit sequence R-1 [2] and [3] corresponding to the respective IPIDs of the first packet group and the management bit sequence S-2 [2] and [3] having the corresponding IPIDs. Since a result of the comparison reveals that the packet p3 corresponding to the bit of “1” in both of the management bit sequences R-1 and S-2 is transmitted within the second period, the packet verification apparatus 101 sets the management bit sequence R-1 [3] to “0.” From the foregoing, the packet verification apparatus 101 specifies that the IPID of the packet p2 corresponding to the management bit sequence R-1 [2], which remains “1” in the management bit sequence R-1, is the IPID of the second packet group. Since the packet verification apparatus 101 may specify the IPID of the packet p2 in this manner, it may accurately specify packet loss of the monitoring target apparatus 102 and may improve the accuracy in decision of packet loss.

Further, although it is described above that a packet received or transmitted includes a TCP header or a UDP header in order to specify a session, the present embodiment may be applied also to a packet having a different protocol of the transport layer. Further, if a header other than the IP header, the TCP header, and the UDP header has information with which a received or transmitted packet is specified uniquely, the packet verification apparatus 101 may use the corresponding information in place of the IPID. Further, while the packet verification apparatus 101 in the example of FIG. 1 verifies packet loss of the monitoring target apparatus 102, the packet verification apparatus 101 may verify packet loss of packets transferred from or received by the packet verification apparatus 101 itself. Now, a system including the packet verification apparatus 101 is described with reference to FIG. 2.

FIG. 2 is an explanatory view illustrating an example of a configuration of an information processing system. An information processing system 200 depicted in FIG. 2 includes the packet verification apparatus 101 and the monitoring target apparatus 102. In the example of FIG. 2, the packet verification apparatus 101 couples to a reception side mirror port 201 and a transmission side mirror port 202 of the monitoring target apparatus 102.

The monitoring target apparatus 102 is an apparatus that is monitored for loss of packets by the packet verification apparatus 101. The monitoring target apparatus may be any apparatus that relays packets. For example, the monitoring target apparatus 102 is a hub, a bridge, a switch, a router or the like. Alternatively, the monitoring target apparatus 102 may be a computer that executes a software router. Here, an arrow mark depicted in FIG. 2 schematically illustrates a flow of a packet relayed by the monitoring target apparatus 102.

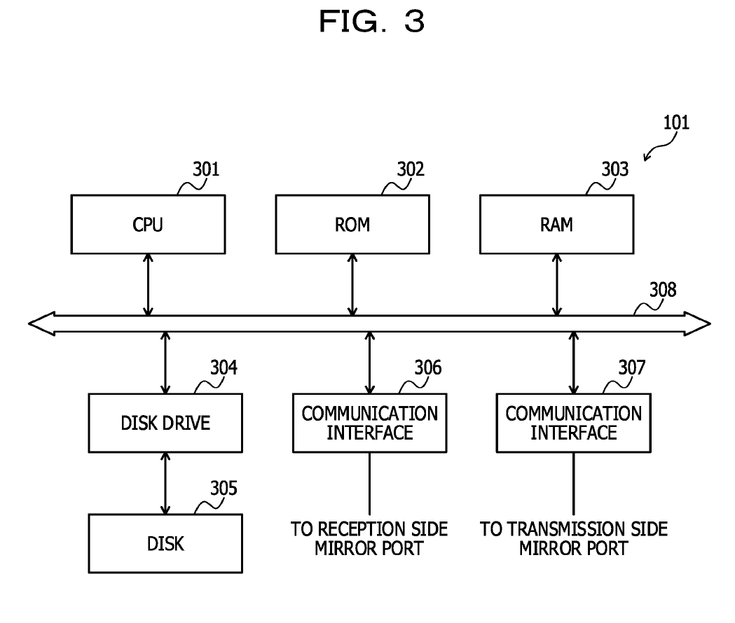

The packet verification apparatus 101 acquires packets of all ports received by the monitoring target apparatus 102 from the reception side mirror port 201 and acquires packets of all ports transmitted by the monitoring target apparatus 102 from the transmission side mirror port 202. Further, the acquisition method of packets by the monitoring target apparatus 102 is not limited to the method described above. For example, a method may be applied by which a TAP is provided for a network cable coupling to the monitoring target apparatus 102. Here, the TAP is an apparatus that copies a frame transferred on the cable and transmits the copied frame to a different apparatus such as the packet verification apparatus 101. Alternatively, another method may be applied by which mirror setting is performed by a switch coupling to the monitoring target apparatus 102. Now, a hardware configuration of the packet verification apparatus 101 is described with reference to FIG. 3.

FIG. 3 is an explanatory view illustrating an example of a hardware configuration of a packet verification apparatus. The packet verification apparatus illustrated in FIG. 3 may be the packet verification apparatus 101 illustrated in FIG. 1. Referring to FIG. 3, the packet verification apparatus 101 includes a CPU 301, a read-only memory (ROM) 302, and a random access memory (RAM) 303. The packet verification apparatus 101 further includes a disk drive 304 and a disk 305, and communication interfaces 306 and 307. Further, the components from the CPU 301 to the disk drive 304 and the communication interfaces 306 and 307 are coupled to each other by a bus 308.

The CPU 301 is an arithmetic processing unit that is responsible for control of the entire packet verification apparatus 101. The ROM 302 is a nonvolatile memory that stores programs such as a boot program. The RAM 303 is a volatile memory that is used as a working area of the CPU 301.

The disk drive 304 is a control apparatus that controls reading and writing of data from and into the disk 305 under the control of the CPU 301. For the disk drive 304, for example, a magnetic disk drive, an optical disk drive, a solid-state drive or the like may be adopted. The disk 305 is a nonvolatile memory for storing data written under the control of the disk drive 304. For example, where the disk drive 304 is a magnetic disk drive, a magnetic disk may be adopted for the disk 305. On the other hand, where the disk drive 304 is an optical disk drive, an optical disk may be adopted for the disk 305. Further, where the disk drive 304 is a solid-state drive, a semiconductor memory including semiconductor elements, for example, a semiconductor disk, may be adopted for the disk 305.

The communication interfaces 306 and 307 are control apparatus that are responsible for interfacing between a network or the like and the inside of packet verification apparatus 101 and control inputting and outputting of data from and to a different apparatus. For example, the communication interface 306 is coupled to the reception side mirror port 201 of the monitoring target apparatus 102. Meanwhile, the communication interface 307 is coupled to the transmission side mirror port 202 of the monitoring target apparatus 102. For the communication interfaces 306 and 307, a network interface card (NIC) such as an Ethernet (registered trademark) card may be adopted.

Where a manager of the information processing system 200 directly operates the packet verification apparatus 101, the packet verification apparatus 101 may include such hardware elements as a display unit, a keyboard, and a mouse.

(Example of Functional Configuration of Packet Verification Apparatus 101)

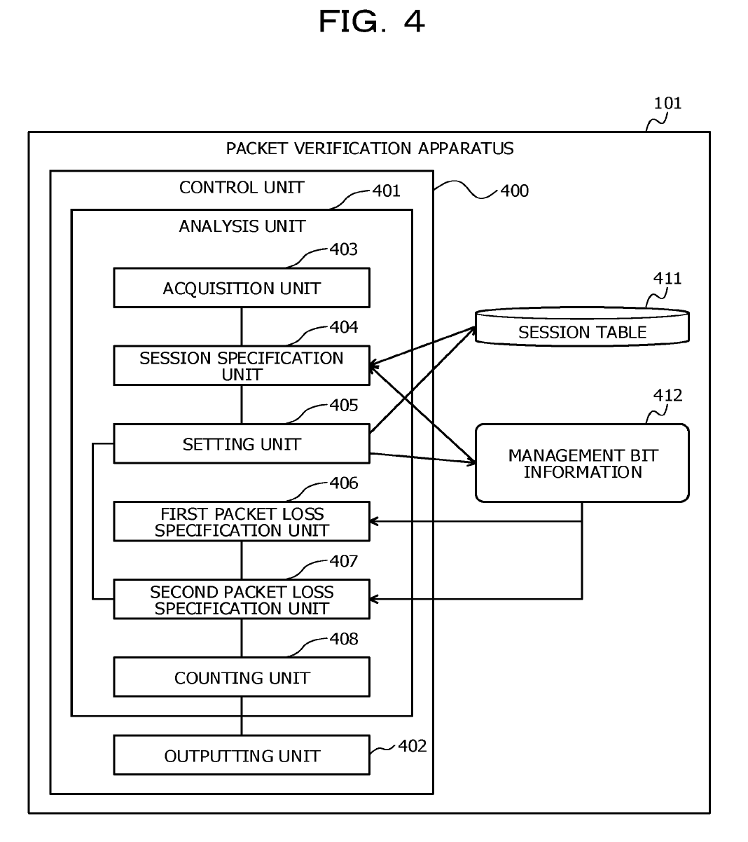

FIG. 4 is an explanatory view illustrating an example of a functional configuration of a packet verification apparatus. The packet verification apparatus illustrated in FIG. 4 may be the packet verification apparatus 101 illustrated in FIG. 1. The packet verification apparatus 101 includes a control unit 400. The control unit 400 includes an analysis unit 401 and an outputting unit 402. The analysis unit 401 includes an acquisition unit 403, a session specification unit 404, a setting unit 405, a first packet loss specification unit 406, a second packet loss specification unit 407, and a counting unit 408. The control unit 400 implements functions of the respective components by execution of programs stored in a storage apparatus by the CPU 301. The storage apparatus is, for example, the ROM 302, the RAM 303, or the disk 305 depicted in FIG. 3. Results of process by the respective components are stored into a register of the CPU 301, a cache memory of the CPU 301, RAM 303 or the like.

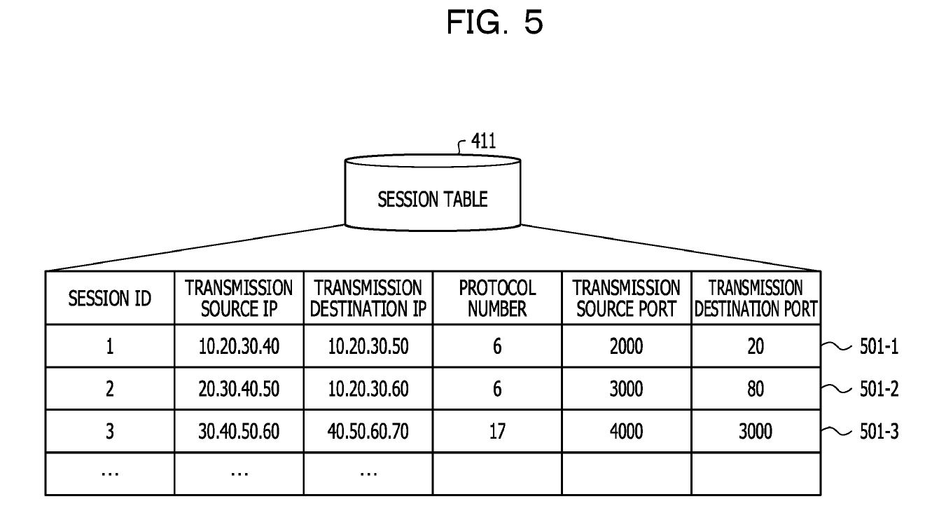

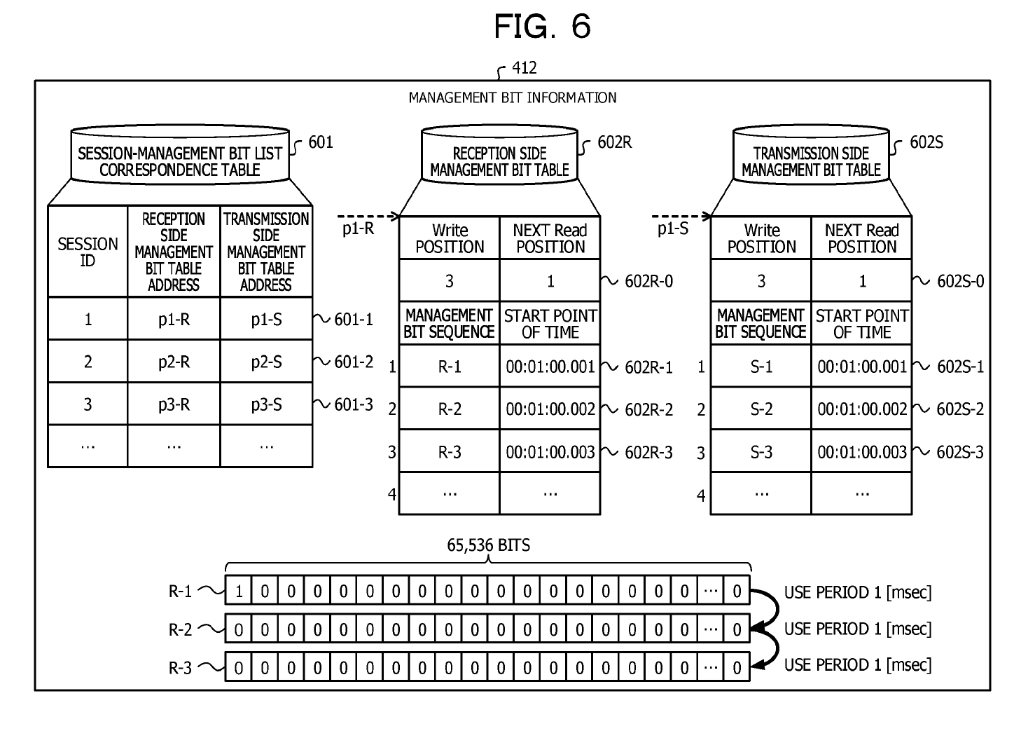

Further, the packet verification apparatus 101 may access a session table 411 and a management bit information 412. The session table 411 and the management bit information 412 are stored in a storage apparatus such as the RAM 303 or the disk 305. The session table 411 is a table for managing sessions. An example of the storage substance of the session table 411 is illustrated in FIG. 5. The management bit information 412 is information including bit groups corresponding to combinations of a session, an IPID of a packet, a period including a point of time at which the packet is received or transmitted, and a type of transmission or reception of the packet. An example of the storage substance of the management bit information 412 is illustrated in FIG. 6.

The acquisition unit 403 acquires a received or transmitted packet from the reception side mirror port 201 and the transmission side mirror port 202. Further, the acquisition unit 403 acquires header information of the acquired packet. Here, the header information is an IP header and a TCP header or a UDP header.

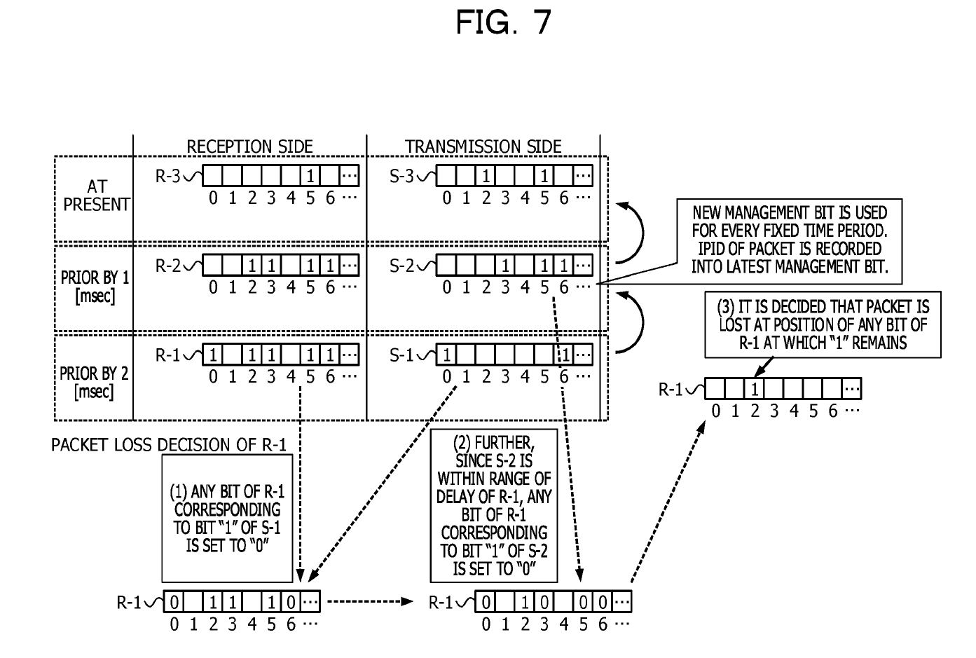

Here, in the present embodiment, as a decision method of packet loss, three methods of first to third working examples are described. First, a function according to the first working example of packet loss decision is described. Details of the first working example of packet loss decision are described with reference to FIGS. 7 to 11.

The session specification unit 404 refers to the session table 411 to specify, from the management bit information 412, respective bits corresponding to a session to which a packet acquired by the acquisition unit 403 belongs.

The setting unit 405 sets, from among respective bits corresponding to combinations of the IPID of a packet, a period including a point of time at which the packet is received or transmitted, and a type of transmission or reception of the packet, any bit that corresponds to any of the received or transmitted packets to “1.”

The first packet loss specification unit 406 specifies each IPID of the first packet group based on a result of comparison between a management bit sequence on the reception side within the first period and a management bit sequence on the transmission side within the first period. A particular specification method is such as described with reference to FIG. 1.

Alternatively, the first packet loss specification unit 406 may specify each IPID of the first packet group according to a specified session based on a result of comparison between management bit sequences on the reception side and the transmission side within the first period from among the respective bits specified by the session specification unit 404.

The second packet loss specification unit 407 specifies each IPID of the second packet group based on the respective IPIDs of the first packet group specified by the first packet loss specification unit 406 and the management bit sequence on the transmission side within the second period.

Further, the second packet loss specification unit 407 specifies, based on the respective IPIDs of the first packet group and the management bit sequence on the transmission side within a next period, each IPID of the packet group that is received within the first period, besides is not transmitted within any of the first period and the next period. The next period is a period from a point of time of the end of the first period to another point of time at which a maximum delay period of the monitoring target apparatus 102 elapses from the point of time of the end. Here, the packet verification apparatus 101 stores the maximum delay period in advance through inputting by a manager of the packet verification apparatus 101 or the like. Alternatively, the packet verification apparatus 101 may transmit, before it performs packet loss decision, a packet for a test to the monitoring target apparatus 102 to measure the maximum delay period.

For example, it is assumed that the first period is 0th to 1st millisecond and the maximum delay period is 1.2 milliseconds. Further, it is assumed that the management bit information 412 includes management bit sequences on the reception side and the transmission side within the first period from 0th to 1st millisecond, a management bit sequence on the transmission side within another period from 1st to 2nd millisecond, and a management bit sequence on the transmission side within a further period from 2nd to 3rd millisecond. Since the maximum delay period is 1.2 milliseconds, a packet received within the first period is transmitted in 2.2 milliseconds at the latest. Accordingly, the second packet loss specification unit 407 uses management bit sequences on the transmission side within the period from 1st to 2nd millisecond and the period from 2nd to 3rd millisecond which overlap with the period of 1st to 2.2 millisecond which is a period from the end time point of the first period to a point of time at which the maximum delay period elapses from the end time point described above.

Further, the second packet loss specification unit 407 specifies, corresponding to a session, each IPID of the second packet group based on the respective IPIDs of the first packet group specified according to the session and a bit sequence corresponding to packets transmitted within the second period.

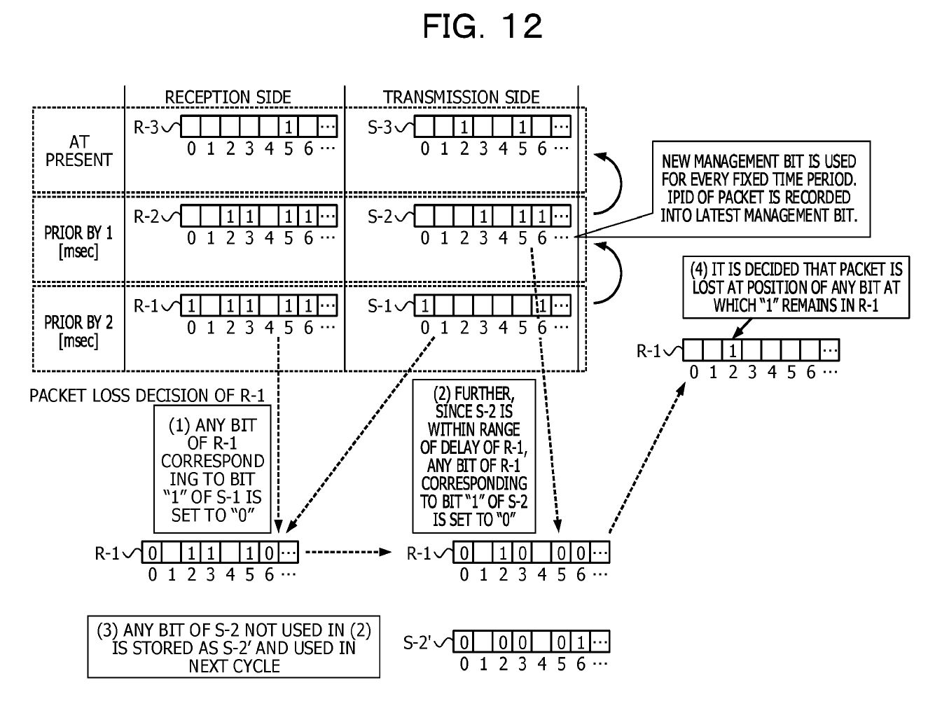

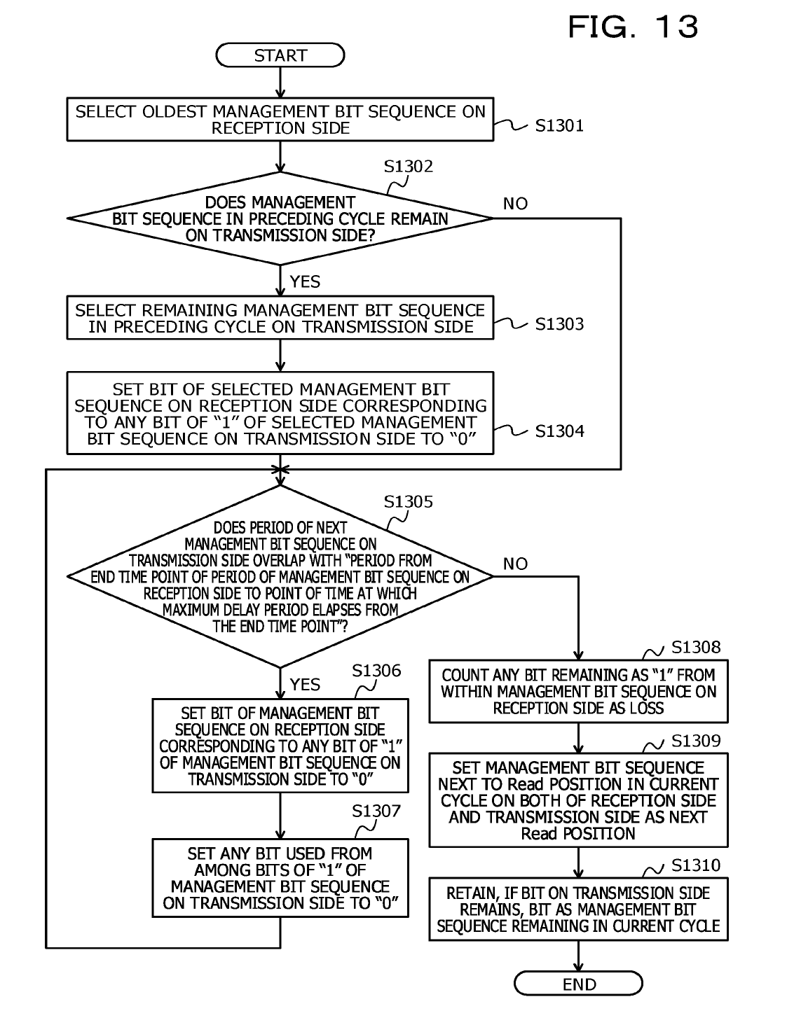

Now, a function for packet loss decision in the second working example is described. The second working example is directed to a method that adds some function to the first working example. Details of the second working example are described with reference to FIGS. 12 and 13. The setting unit 405 sets, from within a management bit sequence on the transmission side within the second period, those bits corresponding to the respective packets of the first packet group specified by the first packet loss specification unit 406 to “0.”

Further, a function for packet loss decision in the third working example is described. The third working example is directed to a method that adds some function to the first or second working example. Details of the third working example are described with reference to FIGS. 14 to 20. It is assumed that, when a bit corresponding to a received or transmitted packet from among the respective bits is set as valid, the bit corresponding to the packet described above already is “1.” In this case, the setting unit 405 adds to the management bit information 412 a bit sequence corresponding to a period that includes a point of time at which the packet is received or transmitted.

The first packet loss specification unit 406 specifies each IPID of the first packet group based on a result of comparison between one or a plurality of management bit sequences on the reception side within the first period from among the respective bits and one or a plurality of management bit sequences on the transmission side within the first period from among the respective bits.

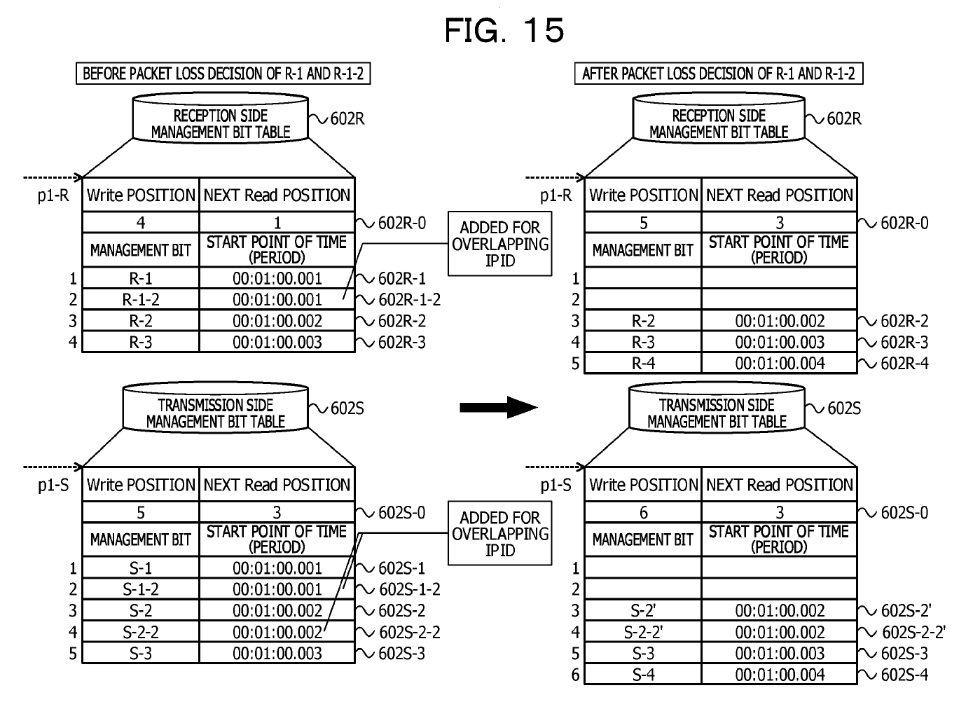

Then, the second packet loss specification unit 407 specifies each IPID of the second packet group based on the respective IPIDs of the first packet group specified by the first packet loss specification unit 406 and one or a plurality of bit sequences on the transmission side within the second period from among the respective bits. A particular specification method is described with reference to FIGS. 14 and 15.

A function described subsequently is common to the first to third working examples. The counting unit 408 counts, based on the respective IPIDs of the second packet group specified corresponding to the combination, the number of lost packets corresponding to the combination.

The outputting unit 402 outputs the number of lost packets corresponding to the session counted by the counting unit 408. As an outputting form, for example, if the packet verification apparatus 101 includes a display unit or a printer, there is outputting by displaying on the display unit or by printing by the printer. Alternatively, the outputting unit 402 may store the number of lost packets into a storage area of the disk 305 or the like.

FIG. 5 is an explanatory view illustrating an example of storage substance of a session table. The session table illustrated in FIG. 5 may be the session table 411 illustrated in FIG. 4. The session table 411 illustrated in FIG. 5 includes records 501-1 to 501-3.

The session table 411 includes fields for a session ID, a transmission source IP, a transmission destination IP, a protocol number, a transmission source port, and a transmission destination port. In the session ID field, information for identifying a session is placed. In the transmission source IP field, a value indicative of a transmission source IP address included in the IP header is placed. In the transmission destination IP field, a value indicative of a transmission destination IP address included in the IP header is placed. In the protocol number field, a value indicative of a protocol number included in the IP header is placed. In the transmission source port field, a value indicative of the transmission source port included in the TCP header or the UDP header is placed. In the transmission destination port field, a value indicative of the transmission destination port included in the TCP header or the UDP header is placed.

For example, the record 501-1 is a record relating to the session ID “1.” The packet whose session ID is “1” is a packet which has a transmission source IP of 10.20.30.40; a transmission destination IP of 10.20.30.50; a protocol number of 6; a transmission source port of 2,000; and a transmission destination port of 20. Here, since the protocol number is 6, the protocol of the transport layer is TCP. In the following, the storage substance of the management bit information 412 is described with reference to FIG. 6.

FIG. 6 is an explanatory view illustrating an example of storage substance of management bit information. The management bit information illustrated in FIG. 6 may be the management bit information 412 illustrated in FIG. 4. The management bit information 412 illustrated in FIG. 6 includes a session-management bit list correspondence table 601, a reception side management bit table 602R, and a transmission side management bit table 602S.

The session-management bit list correspondence table 601 is a table for storing a session and a management bit table in an associated relationship with each other. The session-management bit list correspondence table 601 illustrated in FIG. 6 includes records 601-1 to 601-3.

The session-management bit list correspondence table 601 includes fields for a session ID, a reception side management bit table address, and a transmission side management bit table address. In the session ID field, a number for identifying a session is placed. In the reception side management bit table address field, a top address of the reception side management bit table 602R corresponding to the session is placed. In the transmission side management bit table address field, a top address of the transmission side management bit table 602S corresponding to the session is placed.

For example, the record 601-1 indicates that the top address of the reception side management bit table 602R corresponding to the session ID “1” is p1-R, and the top address of the transmission side management bit table 602S corresponding to the session ID “1” is p1-S.

The reception side management bit table 602R is a table for managing management bit sequences on the reception side. The reception side management bit table 602R illustrated in FIG. 6 includes records 602R-0 to 602R-3. Here, the record 602R-0 is a record including a Write position field and a next Read position field. In the Write position field, a value indicative of the position of a management bit sequence in which a bit is being set is placed. In the next Read position field, a value indicative of the position of a management bit sequence to be read out when next packet loss decision is to be performed is placed.

Further, the record 602R-1 and the following records include fields for a management bit sequence and a start point of time. In the management bit sequence field, a top address of the management bit sequence is placed. In the start time field, a value indicative of a point of time at which setting of a bit to the pertaining management bit sequence is started.

For example, the record 602R-0 indicates that a management bit sequence in which a bit is being set is a third bit sequence from above, alternatively, the management bit sequence R-3, and the management bit sequence to be read out when next packet loss decision is to be performed is a first bit sequence from above, alternatively, the management bit sequence R-1. Meanwhile, the record 602R-1 indicates that the point of time at which setting of a bit to the management bit sequence R-1 is started is “00:01:00.001.” Further, in the present embodiment, the use period of a management bit sequence is one millisecond.

The transmission side management bit table 602S is a table for managing management bit sequences on the transmission side. The transmission side management bit table 602S illustrated in FIG. 6 includes records 602S-0 to 602S-3. Here, the record 602S-0 is a record including a Write position field and a next Read position field. In the Write position field, a value indicative of the position of a management bit sequence in which a bit is being set is placed. In the next Read position field, a value indicative of the position of a management bit sequence to be read out when next packet loss decision is to be performed is placed.

Meanwhile, the record 602S-1 and the following records include fields for a management bit sequence and a start point of time. In the management bit sequence field, a top address of the management bit sequence is placed. In the start time field, a value indicative of a point of time at which setting of a bit to the pertaining management bit sequence is started is placed.

A management bit sequence is a bit sequence of 65,536 bits by which, for each of a session, reception and transmission, numbers of 16 bits, for example, 0 to 65,535 that may be assumed by an IPID, may be identified. The packet verification apparatus 101 classifies an arriving packet for each session and sets the bit corresponding to the IPID of the arriving packet to “1.”

By preparing a management bit sequence separately for the reception side and the transmission side in this manner, the packet verification apparatus 101 may suppress locking by access to the management bit sequence.

(Explanation of Working Example 1 Regarding Packet Loss Decision)

Now, a working example 1 regarding packet loss decision is described with reference to FIGS. 7 to 11. The working example 1 is directed to a method of performing packet loss decision for one management bit sequence on the reception side using a plurality of management bit sequences on the transmission side taking displacement between arriving time points of reception and transmission.

FIG. 7 is an explanatory view illustrating an example of operation for packet loss decision in the working example 1. Packet loss decision of the management bit sequence R-1 is illustrated in FIG. 7. Here, it is assumed that, at the current point of time, the packet verification apparatus 101 are setting the respective bits of the management bit sequences R-3 and S-3 that are the latest management bit sequences. Further, it is assumed that the maximum delay period in the monitoring target apparatus 102 is 200 microseconds. Accordingly, when the packet verification apparatus 101 decides packet loss of the management bit sequence R-1 prior by two milliseconds to the current point of time, the packet verification apparatus 101 compares the management bit sequence R-1 with the management bit sequence S-1 within the same period and further compares the management bit sequence R-1 also with the management bit sequence S-2 prior by one millisecond. The period of the management bit sequence S-2 is a period corresponding to the maximum delay period in the monitoring target apparatus 102 after the last point of time of the period of the management bit sequence R-1. After using the management bit sequence on the transmission side which covers the period corresponding to the maximum delay period in the monitoring target apparatus 102 after the last point of time of the period of the management bit sequence on the reception side, the packet verification apparatus 101 decides that a packet corresponding to any bit at which “1” remains in the management bit sequence on the reception side is lost.

As indicated by (1) in FIG. 7, the packet verification apparatus 101 sets a bit of the management bit sequence R-1 corresponding to any bit of “1” in the management bit sequence S-1 to “0.” For example, in the example of FIG. 7, since the management bit sequence S-1 [0] and [6] is “1,” the packet verification apparatus 101 sets the management bit sequence R-1 [0] and [6] to “0.”

Further, since the management bit sequence S-2 is within a range of delay of the management bit sequence R-1, as indicated by (2) in FIG. 7, the packet verification apparatus 101 sets a bit of the management bit sequence R-1 corresponding to any bit of “1” in the management bit sequence S-2 to “0.” For example, in the example of FIG. 7, since the management bit sequence S-2 [3], [5], and [6] is “1,” the packet verification apparatus 101 sets the management bit sequence R-1 [3] and [5] to “0.”

Then, as indicated by (3) in FIG. 7, the packet verification apparatus 101 decides that the position of any bit at which “1” remains in the management bit sequence R-1 is packet loss. For example, in the example of FIG. 7, since the management bit sequence R-1 [2] is “1,” the packet verification apparatus 101 decides that a packet corresponding to the management bit sequence R-1 [2] is lost.

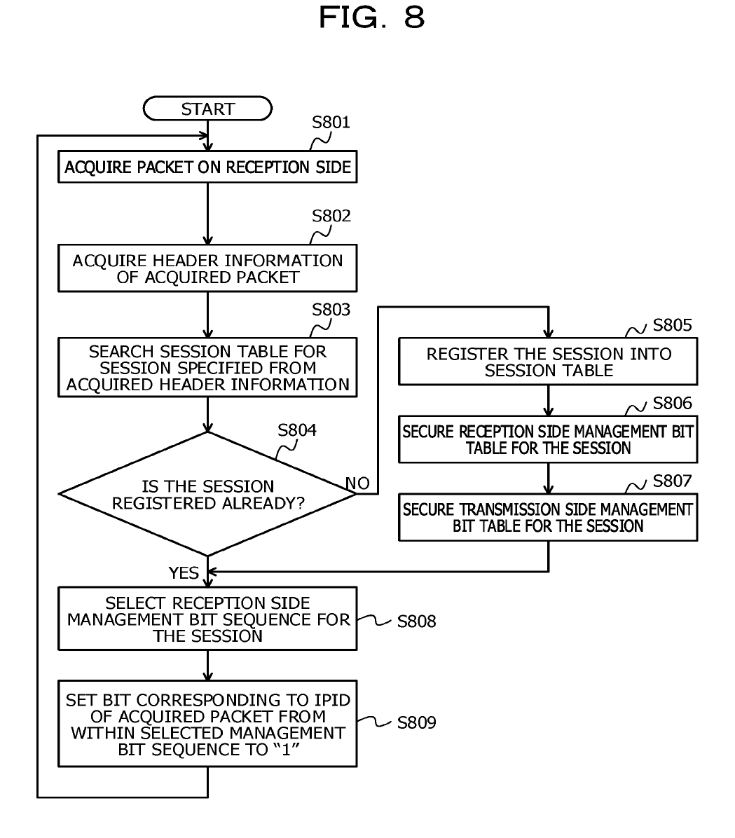

Now, a process executed by the packet verification apparatus 101 in the working example 1 is described with reference to flow charts of FIGS. 8 to 11.

FIG. 8 is a flow chart illustrating procedure for a packet analysis process on a reception side in the working example 1. The packet analysis process on the reception side is a process for analyzing a packet received by the monitoring target apparatus 102.

The packet verification apparatus 101 acquires a packet on the reception side from the reception side mirror port 201 (step S801). Then, the packet verification apparatus 101 acquires header information of the acquired packet (step S802). Then, the packet verification apparatus 101 searches the session table 411 for a session specified from the acquired header information (step S803). Then, the packet verification apparatus 101 decides whether or not the session is registered already (step S804).

If the session specified from the acquired header information is not registered as yet (step S804: No), the packet verification apparatus 101 registers the session into the session table 411 (step S805). Further, the packet verification apparatus 101 secures a reception side management bit table 602R for the session (step S806). Further, the packet verification apparatus 101 secures a transmission side management bit table 602S for the session (step S807). Here, the packet verification apparatus 101 may secure, as the management bit sequences corresponding to the reception side management bit table 602R and the transmission side management bit table 602S, only management bit sequences for a period including the current point of time or may additionally secure a management bit sequence for a next period.

After the process at step S807 comes to an end, or when the session is registered already (step S804: Yes), the packet verification apparatus 101 selects the management bit sequence on the reception side for the session (step S808). Then, the packet verification apparatus 101 sets the bit corresponding to the IPID of any packet acquired from within the selected management bit sequence to “1” (step S809). After the process at step S809 comes to an end, the packet verification apparatus 101 advances the process to step S801.

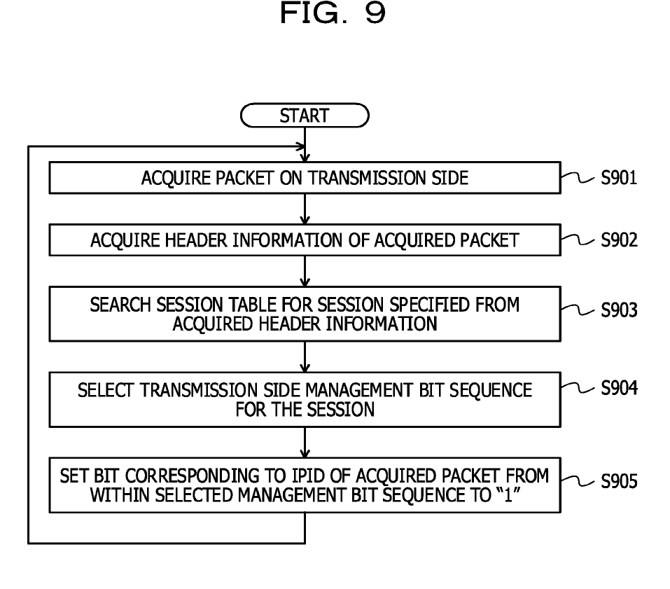

FIG. 9 is a flow chart illustrating procedure for a packet analysis process on a transmission side in the working example 1. The packet analysis process on the transmission side is a process for analyzing a packet transmitted from the monitoring target apparatus 102.

The packet verification apparatus 101 acquires a packet on the transmission side from the transmission side mirror port 202 (step S901). Then, the packet verification apparatus 101 acquires header information of the acquired packet (step S902). Then, the packet verification apparatus 101 searches the session table 411 for a session specified from the acquired header information (step S903).

Then, the packet verification apparatus 101 selects the management bit sequence on the transmission side for the session (step S904). Then, the packet verification apparatus 101 sets the bit corresponding to the IPID of the acquired packet from within the selected management bit sequence to “1” (step S905). After the process at step S905 comes to an end, the packet verification apparatus 101 advances the process to step S901.

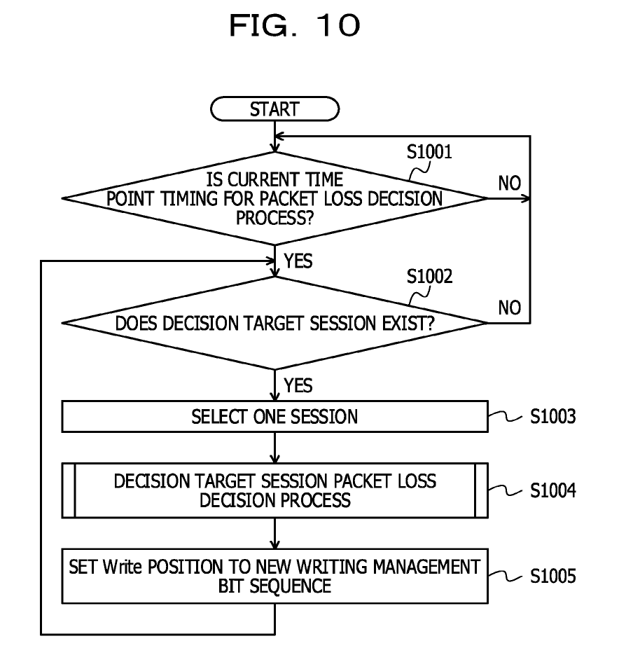

FIG. 10 is a flow chart illustrating procedure for a packet loss decision process in the working example 1. The packet loss decision process is a process for deciding packet loss of the monitoring target apparatus 102.

The packet verification apparatus 101 decides whether or not the current point of time is a timing for the packet loss decision process (step S1001). Here, the first timing for the packet loss decision process is a point of time at which, after a packet is acquired first, a trial period including a period of time obtained by adding the maximum delay period of the monitoring target apparatus 102 to the use period of a management bit sequence elapses by a minimum number of times. For example, if the use period is one millisecond and the maximum delay period of the monitoring target apparatus 102 is 200 microseconds, the minimum number of times is 2, and the first timing is a timing at which two milliseconds elapse after the packet is acquired first. Each of the second and succeeding timings is a timing at which the trial period elapses after the preceding timing.

If the current point of time is not a timing for the packet loss decision process (step S1001: No), the packet verification apparatus 101 advances the process to step S1001. On the other hand, if the current point of time is a timing for the packet loss decision process (step S1001: Yes), the packet verification apparatus 101 decides whether or not a decision target session or sessions exist (step S1002). Here, the decision target sessions are all sessions registered in the session table 411. Alternatively, the packet verification apparatus 101 may decide, from among the sessions registered in the session table 411, those sessions that include a particular transmission source port or a particular transmission destination port as the decision target sessions depending upon settings or the like of the manager of the packet verification apparatus 101.

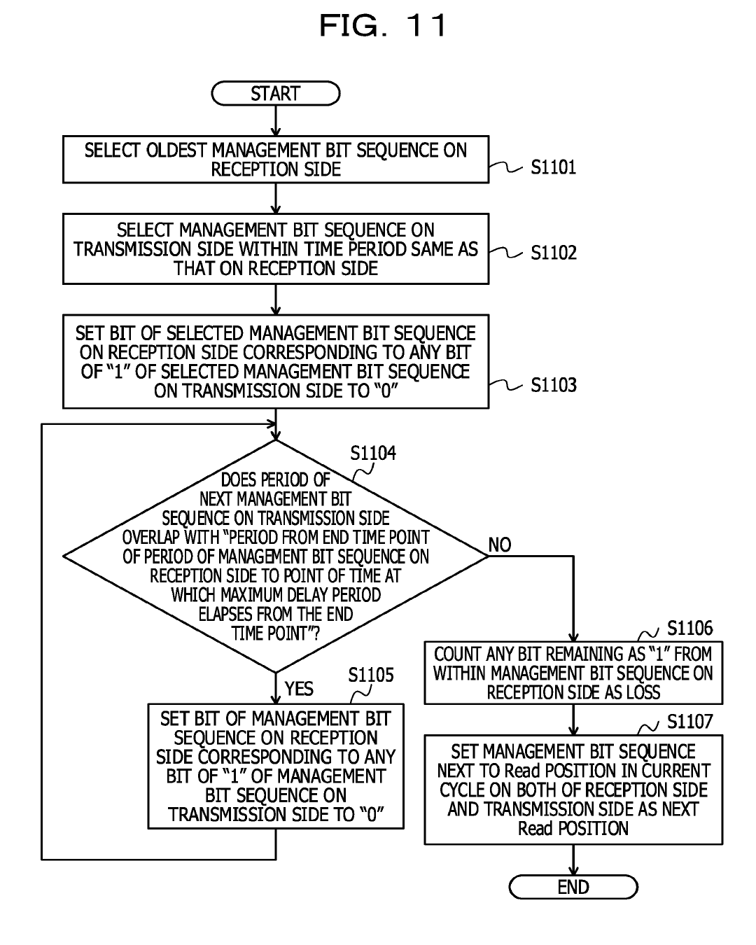

If no decision target session exists (step S1002: No), the packet verification apparatus 101 advances the process to step S1001. On the other hand, if a decision target session or sessions exist (step S1002: Yes), the packet verification apparatus 101 selects one of the decision target sessions (step S1003). Then, the packet verification apparatus 101 executes a decision target session packet loss decision process for the selected session (step S1004). The decision target session packet loss decision process is described with reference to FIG. 11. Then, the packet verification apparatus 101 sets a Write position to a new writing management bit sequence (step S1005). Then, the packet verification apparatus 101 advances the process to step S1002.

FIG. 11 is a flow chart illustrating procedure for a decision target session packet loss decision process in the working example 1. The decision target session packet loss decision is a process for deciding packet loss of a decision target session and counting the number of lost packets.

The packet verification apparatus 101 selects the oldest management bit sequence on the reception side (step S1101). Here, the oldest management bit sequence on the reception side is the management bit sequence corresponding to the next Read position. Then, the packet verification apparatus 101 selects the management bit sequence on the transmission side within the same period as that on the reception side (step S1102). Then, the packet verification apparatus 101 sets a bit of the selected management bit sequence on the reception side corresponding to any bit of “1” of the selected management bit sequence on the transmission side to “0” (step S1103).

Then, the packet verification apparatus 101 decides whether or not the period of the next management bit sequence on the transmission side overlaps with a “period from the end time point of the period of the management bit sequence on the reception side to a point of time at which the maximum delay period elapses from the end time point” (step S1104).

For example, it is assumed that the management bit sequence on the reception side is R-1 and the next management bit sequence on the transmission side is S-2, and the start time points of the management bit sequences are individually such as illustrated in FIG. 6. Further, it is assumed that the maximum delay period is 200 microseconds. In this case, the end time point of the period of the management bit sequence on the reception side is 00:01:00.002. Then, the time point at which the maximum delay period elapses from the end time point is 00:01:00.0022. The period of the management bit sequence S-2 is a period from 00:01:00.002 to 00:01:00.003 and overlaps with the period from the end time point to the time point at which the maximum delay period elapses from the end time point. Therefore, the packet verification apparatus 101 makes an affirmative decision (Yes) at step S1104.

Meanwhile, as another example, it is assumed that the management bit sequence on the reception side is R-1 and the next management bit sequence on the transmission side is S-2, and the start time points of the management bit sequences are individually such as illustrated in FIG. 6. Further, it is assumed that the maximum delay period is 1,200 microseconds. In this case, the end time point of the period of the management bit sequence on the reception side is 00:01:00.002. Then, the time point at which the maximum delay period elapses from the end time point is 00:01:00.0032. The period of the management bit sequence S-2 is a period from 00:01:00.002 to 00:01:00.003 and overlaps with the period from the end time point to the time point at which the maximum delay period elapses from the end time point. Therefore, the packet verification apparatus 101 makes an affirmative decision (Yes) at step S1104. Further, it is assumed that the next management bit sequence on the transmission side becomes S-3. In this case, the period of the management bit sequence S-2 is a period from 00:01:00.003 to 00:01:00.004 and overlaps with the period from the end time point to the time point at which the maximum delay period elapses from the end time point. Therefore, the packet verification apparatus 101 makes an affirmative decision (Yes) at step S1104.

If the period of the next management bit sequence on the transmission side overlaps with the “period” described above (step S1104: Yes), the packet verification apparatus 101 sets a bit of the management bit sequence on the reception side corresponding to any bit of “1” of the management bit sequence on the transmission side to “0” (step S1105). Then, the packet verification apparatus 101 advances the process to step S1104.

On the other hand, if the period of the next management bit sequence on the transmission side does not overlap with the “period” described hereinabove (step S1104: No), the packet verification apparatus 101 counts the remaining bits of “1” from within the management bit sequence on the reception side as loss (step S1106). Then, the packet verification apparatus 101 sets the management bit sequence next to the Read position in the current cycle on both of the reception side and the transmission side to the next Read position (step S1107). After the process at step S1107 comes to an end, the packet verification apparatus 101 ends the decision target session packet loss decision process.

(Explanation of Working Example 2 Regarding Packet Loss Decision)

Now, the working example 2 regarding a packet loss decision is described with reference to FIGS. 12 and 13. The working example 2 is directed to a method that stores, when management bit sequences on the reception side and the transmission side are compared with each other, bits of the management bit sequence on the transmission side which are not used for the comparison and uses the stored bits for a packet loss decision in a next cycle in addition to the method of the working example 1. It is to be noted that like elements to those in the description of the working example 1 are denoted by the same reference symbols and overlapping illustration and description of them are omitted.

FIG. 12 is an explanatory view illustrating an example of operation for packet loss decision in the working example 2. FIG. 12 illustrates packet loss decision of a management bit sequence R-1. Processes (1), (2), and (4) of FIG. 12 are same as those of (1) to (3) of FIG. 7, and therefore, description of them is omitted herein.

As indicated by (3) of FIG. 12, bits of the management bit sequence S-2 which are not used in the process (2) of FIG. 12 are stored as a management bit sequence S-2′ and are used upon packet loss decision in the next cycle. In the example of FIG. 12, the management bit sequence S-2 [6] from within the management bit sequence S-2 [3], [5], and [6] is not used. Accordingly, the packet verification apparatus 101 stores the management bit sequence S-2′ in which the management bit sequence S-2 [6] is set to “1” while the other bits are set to “0.”

Now, a process executed by the packet verification apparatus 101 in the working example 2 is described with reference to a flow chart of FIG. 13. Here, a packet analysis process on the reception side, a packet analysis process on the transmission side, and a packet loss decision process in the working example 2 are same as those in the working example 1, and therefore, description and illustration of them are omitted.

FIG. 13 is a flow chart illustrating procedure for a decision target session packet loss decision process in the working example 2. Here, processes at steps S1301, S1305, S1306, S1308, and S1309 in FIG. 13 are same as the processes at steps S1101 and S1104 to S1107, and therefore, description of the processes is omitted herein.

After the process at step S1301 comes to an end, the packet verification apparatus 101 decides whether or not a management bit sequence in the preceding cycle remains on the transmission side (step S1302). Here, if the current point of time is a timing for packet loss decision process for the first time, the packet verification apparatus 101 makes a decision of No at step S1302.

If a management bit sequence in the preceding cycle remains on the transmission side (step S1302: Yes), the packet verification apparatus 101 selects the remaining management bit sequence in the preceding cycle on the transmission side (step S1303). Then, the packet verification apparatus 101 sets a bit of the selected management bit sequence on the reception side corresponding to any bit of “1” of the selected management bit sequence on the transmission side to “0” (step S1304).

Then, after the process at step S1304 comes to an end or when no management bit sequence in the preceding cycle remains on the transmission side (step S1302: No), the packet verification apparatus 101 executes the process at step S1305.

After the process at step S1306 comes to an end, the packet verification apparatus 101 sets any bit used in the process at step S1306 from among the bits of “1” of the management bit sequence on the transmission side to “0” (step S1307). After the process at step S1307 comes to an end, the packet verification apparatus 101 advances the process to step S1305.

After the process at step S1309 comes to an end, if some bits on the transmission side remain, the packet verification apparatus 101 retains the remaining bits as a management bit sequence remaining in the current cycle (step S1310). After the process at step S1310 comes to an end, the packet verification apparatus 101 ends the decision target session packet loss decision process.

(Explanation of Working Example 3 Regarding Packet Loss Decision)

Now, the working example 3 for packet loss decision is described with reference to FIGS. 14 to 20. The working example 3 is directed to a method ready also with a case in which the IPID varies at random for each session or for each terminal. When the IPID varies at random, there is the possibility that a plurality of packets having the same IPID may arrive within a use period of one management bit sequence. Accordingly, the working example 3 is directed to a method that adds, when a plurality of packets having the same IPID arrive during a use period of one management bit sequence, a new management bit sequence in addition to the method of the working example 1 or 2. In the working example 3, the description with reference to FIGS. 14 to 20 is directed to a method added to the method of the working example 2. It is to be noted that like elements to those described in connection with the working example 1 or 2 are denoted by the same reference symbols and illustration and description are omitted.

FIG. 14 is an explanatory view (part 1) illustrating an example of operation for packet loss decision in the working example 3. FIG. 14 illustrates packet loss decision at a point of time prior by two milliseconds to the current point of time. Packets received prior by two milliseconds to the current point of time include packets whose IPIDs overlap with each other, and in order to specify each of the packets, the packet verification apparatus 101 stores a management bit sequence R-1-2 added to the management bit sequence R-1. Similarly, the packet verification apparatus 101 stores a management bit sequence S-1-2 added to the management bit sequence S-1 and a management bit sequence S-2-2 added to the management bit sequence S-2. In the following description, a management bit sequence represented like “R-X-2” or “S-X-2” is an added management bit sequence.

As indicated by (1) of FIG. 14, bits of the management bit sequences R-1 and R-1-2 prior by two milliseconds to the current point of time corresponding to bits of “1” of the management bit sequences S-1 and S-1-2 are set to “0.” For example, in the example of FIG. 14, since the management bit sequences S-1 [0] and [6] and S-1-2 [0] are “1,” the packet verification apparatus 101 sets the management bit sequence R-1 [0] and the management bit sequence R-1-2 [0] and [6] to “0.”

Further, since the management bit sequences S-2 and S-2-2 are within the range of delay of the management bit sequence R-1, as indicated by (2) of FIG. 14, the packet verification apparatus 101 sets a bit of the management bit sequence R-1 corresponding to any bit of “1” in the management bit sequences S-2 and S-2-2 to “0.” For example, in the example of FIG. 14, since the management bit sequence S-2 [3], [5], and [6], and the management bit sequence S-2-2 [6] are “1,” the packet verification apparatus 101 sets the management bit sequence R-1 [3], [5], and [6] to “0.”

Here, in (1) and (2) of FIG. 14, in what order a decision of a bit is to be performed in regard to the management bit sequences R-1 and R-1-2 and the management bit sequences S-1 and S-1-2 is determined arbitrarily. In the example of FIG. 14, decision is performed beginning with a newly added management bit sequence.

Then, bits, which have not been used in (2) of FIG. 14, of the management bit sequence S-2 are stored as a management bit sequence S-2′ as depicted in (3) of FIG. 14 and are used in packet loss decision in the next cycle. In the example of FIG. 14, from among management bit sequence S-2 [3], [5], and [6], and the management bit sequence S-2-2 [6], the management bit sequence S-2 [6] is not used. Accordingly, the packet verification apparatus 101 stores a management bit sequence S-2′ in which the management bit sequence S-2 [6] is “1” and the other bits are “0.”

Further, after the process of (2) of FIG. 14, the packet verification apparatus 101 decides that packet loss has occurred at the position of any bit of the management bit sequence R-1 at which “1” remains as indicated by (4) of FIG. 14. For example, in the example of FIG. 14, since the management bit sequence R-1 [2] is “1,” the packet verification apparatus 101 decides that a packet corresponding to the management bit sequence R-1 [2] is lost. In the following, the reception side management bit table 602R and the transmission side management bit table 602S when a management bit sequence is added are described with reference to FIG. 15.

FIG. 15 is an explanatory view (part 2) illustrating an example of operation for packet loss decision in the working example 3. Referring to FIG. 15, the reception side management bit table 602R and the transmission side management bit table 602S depicted on the left side in FIG. 15 illustrate a state of the management bit sequences R-1 and R-1-2 depicted in FIG. 14 before packet loss decision. In contrast, the reception side management bit table 602R and the transmission side management bit table 602S depicted on the right side in FIG. 15 illustrate a state of the management bit sequences R-1 and R-1-2 after packet loss decision.

In the state of the management bit sequences R-1 and R-1-2 before packet loss decision, the reception side management bit table 602R has a record 602R-1-2 added thereto which manages the management bit sequence R-1-2 added for an overlapping IPID. Similarly, the transmission side management bit table 602S has added thereto a record 602S-1-2 that manages the management bit sequence S-1-2 added for an overlapping IPID and a record 602S-2-2 that manages the management bit sequence S-2-2.

After packet loss decision of the management bit sequences R-1 and R-1-2, the record 602R-1 for managing the management bit sequence R-1 and the record 602R-1-2 for managing the management bit sequence R-1-2 are deleted from the reception side management bit table 602R. Further, to the reception side management bit table 602R, a record 602R-4 for managing a management bit sequence R-4 within a next period to the management bit sequence R-3 is added, and the Write position indicates 5, for example, the management bit sequence R-4.

Similarly, from the transmission side management bit table 602S, the record 602S-1 for managing the management bit sequence S-1 and the record 602S-1-2 for managing the management bit sequence S-1-2 are deleted. Further, to the transmission side management bit table 602S, a record 602S-4 for managing a management bit sequence S-4 within a next period to the management bit sequence S-3 is added, and the Write position indicates 6, for example, the management bit sequence S-4.

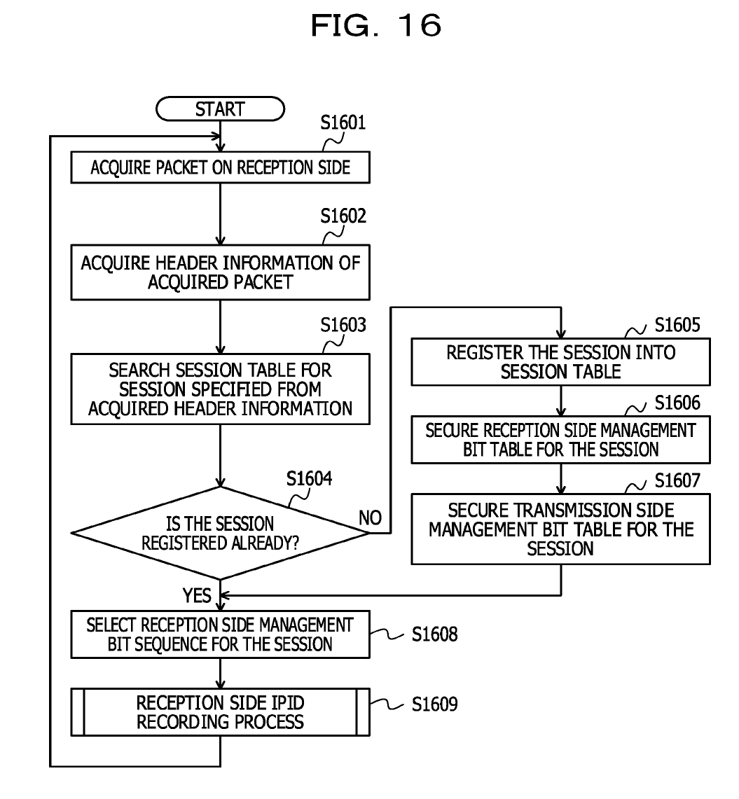

Next, a process executed by the packet verification apparatus 101 in the working example 3 is illustrated in flow charts of FIGS. 16 to 20. Here, since the packet loss decision process in the working example 3 is same as the process in the working example 1, description and illustration of them are omitted herein.

FIG. 16 is a flow chart illustrating procedure for a packet analysis process on a reception side in the working example 3. Here, processes at steps S1601 to S1608 of FIG. 16 are same as the processes at steps S801 to S808, and therefore, description of them is omitted herein.

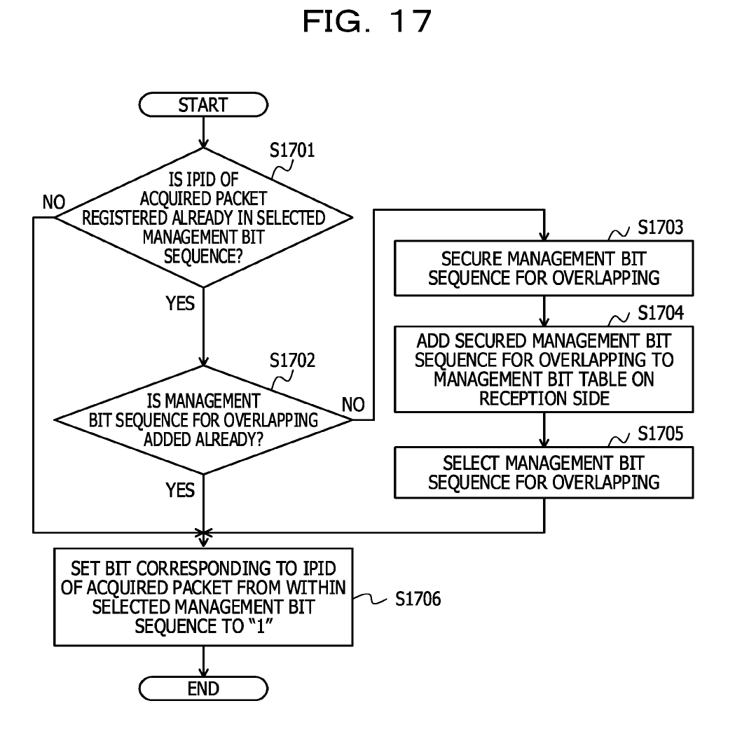

After the process at step S1608 comes to an end, the packet verification apparatus 101 executes a reception side IPID recording process (step S1609). The reception side IPID recording process is illustrated in FIG. 17. Then, the packet verification apparatus 101 advances the process to step S1601.

FIG. 17 is a flow chart illustrating procedure for a reception side IPID recording process. The reception side IPID recording process is a process for setting any bit of the management bit sequence on the reception side corresponding to the IPID of a received packet to “1.”

The packet verification apparatus 101 decides whether or not the IPID of the acquired packet is registered already in a selected management bit sequence (step S1701). If the IPID of the acquired packet is registered already in the selected management bit sequence (step S1701: Yes), the packet verification apparatus 101 decides whether or not a management bit sequence for overlapping is added already (step S1702).

If a management bit sequence for overlapping is not added (step S1702: No), the packet verification apparatus 101 secures a management bit sequence for overlapping (step S1703). Then, the packet verification apparatus 101 adds the secured management bit sequence for overlapping to the management bit table on the reception side (step S1704). Then, the packet verification apparatus 101 selects the management bit sequence for overlapping (step S1705). Then, the packet verification apparatus 101 sets any bit of the selected management bit sequence corresponding to the IPID of the acquired packet to “1” (step S1706).

On the other hand, if the IPID of the acquired packet is not registered in the selected management bit sequence (step S1701: No) or if the management bit sequence for overlapping is added already (step S1702: Yes), the packet verification apparatus 101 executes the process at step S1706. After the process at step S1706 comes to an end, the packet verification apparatus 101 ends the reception side IPID recording process. It is to be noted that the process illustrated in FIG. 17 allows addition of only one management bit sequence for overlapping.

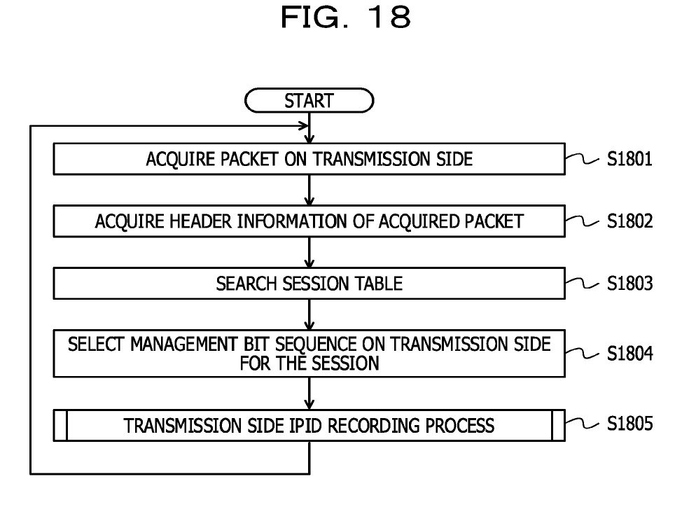

FIG. 18 is a flow chart illustrating procedure for a packet analysis process on a transmission side in the working example 3. Processes at steps S1801 to S1804 in FIG. 18 are same as the processes at steps S901 to S904, and therefore, description of them is omitted herein.

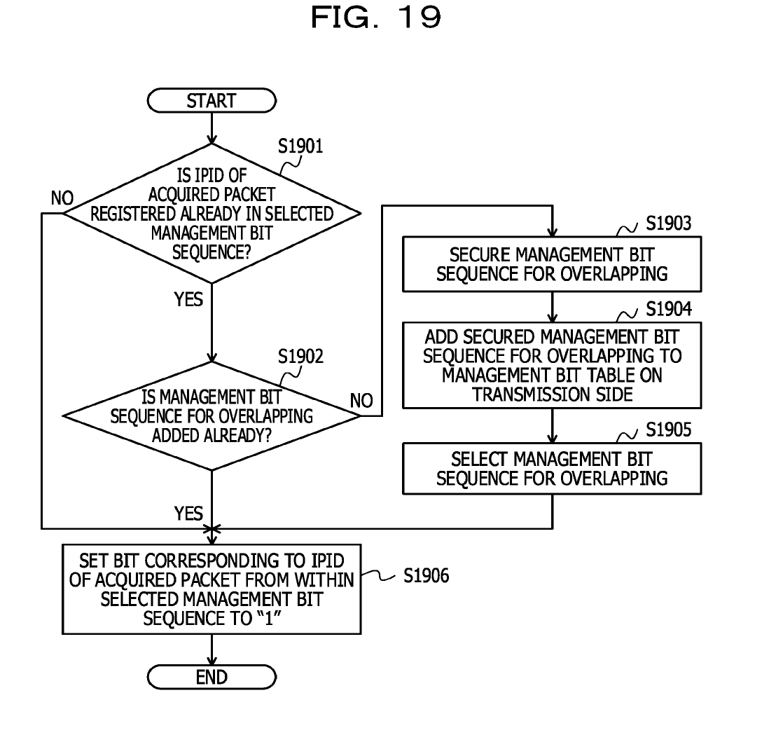

After the process at step S1804 comes to an end, the packet verification apparatus 101 executes a transmission side IPID recording process (step S1805). The transmission side IPID recording process is illustrated in FIG. 19. After the process at step S1805 comes to an end, the packet verification apparatus 101 advances the process to step S1801.

FIG. 19 is a flow chart illustrating procedure for a transmission side IPID recording process. The transmission side IPID recording process is a process for setting any bit of the management bit sequence on the transmission side corresponding to the IPID of a transmitted packet to “1.”

Processes at steps S1901 to S1903, S1905, and S1906 in FIG. 19 are same as the processes at steps S1701 to S1703, S1705, and S1706. Therefore, description of them is omitted herein.

After the process at step S1903 comes to an end, the packet verification apparatus 101 adds the secured management bit sequence for overlapping to the management bit table on the transmission side (step S1904). Then, the packet verification apparatus 101 executes the process at step S1905. It is to be noted that, in the process illustrated in FIG. 17, addition of only one management bit sequence for overlapping is permitted.

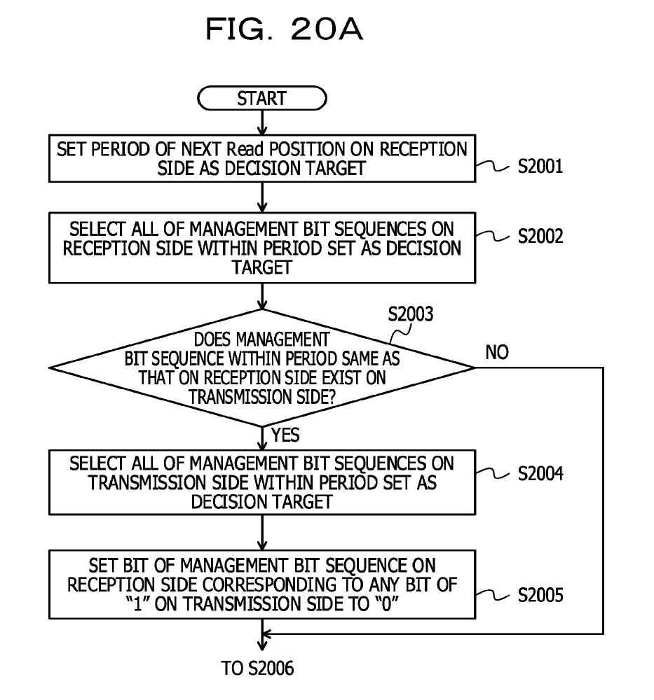

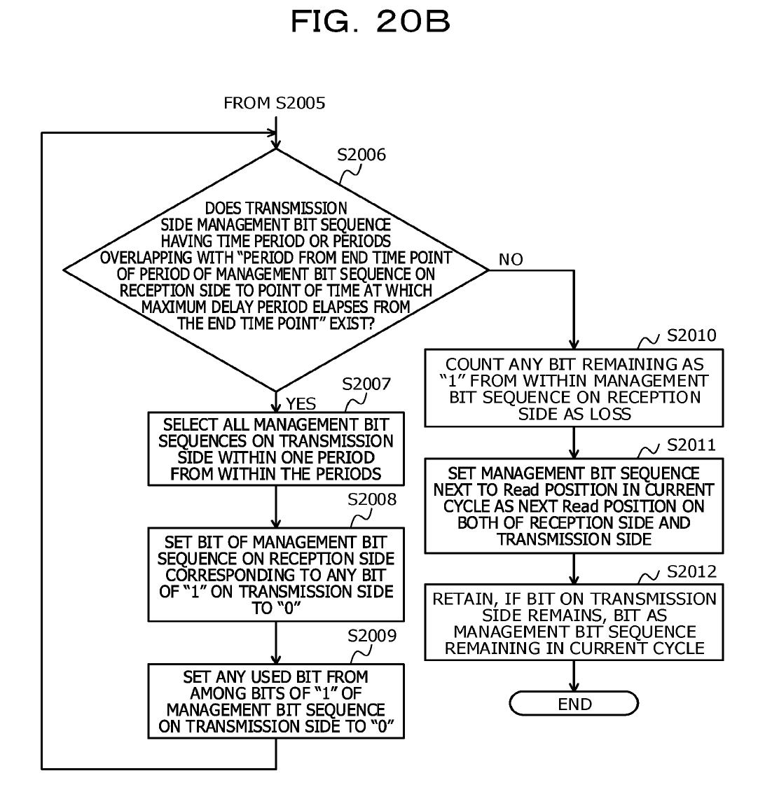

FIGS. 20A and 20B are flow charts illustrating procedure for a decision target session packet loss decision process in the working example 3.

The packet verification apparatus 101 sets a period of the next Read position on the reception side as a decision target (step S2001). Then, the packet verification apparatus 101 selects all management bit sequences on the reception side within the period set as the decision target (step S2002). Then, the packet verification apparatus 101 decides whether or not a management bit sequence or sequences within the same period as that on the reception side exist on the transmission side (step S2003). If a management bit sequence or sequences within the same period as that on the reception side exist on the transmission side (step S2003: Yes), the packet verification apparatus 101 selects all of the management bit sequences on the transmission side within the period set as the decision target (step S2004). Then, the packet verification apparatus 101 sets a bit of the management bit sequences on the reception side corresponding to any of bits of “1” on the transmission side to “0” (step S2005).

Then, the packet verification apparatus 101 decides whether or not there is a transmission side management bit sequence having a period overlapping with a “period from the end time point of the period of the management bit sequence on the reception side to a point of time at which the maximum delay period elapses from the end time point” (step S2006). On the other hand, also when a management bit sequence within the same period as that on the reception side does not exist on the transmission side (step S2003: No), the packet verification apparatus 101 executes the process at step S2006.

If a transmission side management bit sequence having a period or periods overlapping with the “period” described above exists (step S2006: Yes), the packet verification apparatus 101 selects all management bit sequences on the transmission side within one of the periods (step S2007). Then, the packet verification apparatus 101 sets a bit of the management bit sequences on the reception side corresponding to any bit of “1” on the transmission side to “0” (step S2008). Then, the packet verification apparatus 101 sets any bit used in the process at step S2008 from among the bits of “1” of the management bit sequence on the transmission side to “0” (step S2009). Then, the packet verification apparatus 101 advances the process to step S2006.

On the other hand, if a transmission side management bit sequence having a period overlapping with the “period” described hereinabove does not exist (step S2006: No), the packet verification apparatus 101 counts bits that remain as “1” in the management bit sequence on the reception side as loss (step S2010). Then, the packet verification apparatus 101 sets the management bit sequence next to the Read position in the current cycle on both of the reception side and the transmission side to the next Read position (step S2011). Then, if bits on the transmission side remain, the packet verification apparatus 101 retains the bits as a remaining management bit sequence in the current cycle (step S2012). Here, the packet verification apparatus 101 does not retain the management bit sequence on the transmission side within the same period with the reception side period. After the process at step S2012 comes to an end, the packet verification apparatus 101 ends the decision target session packet loss decision process.

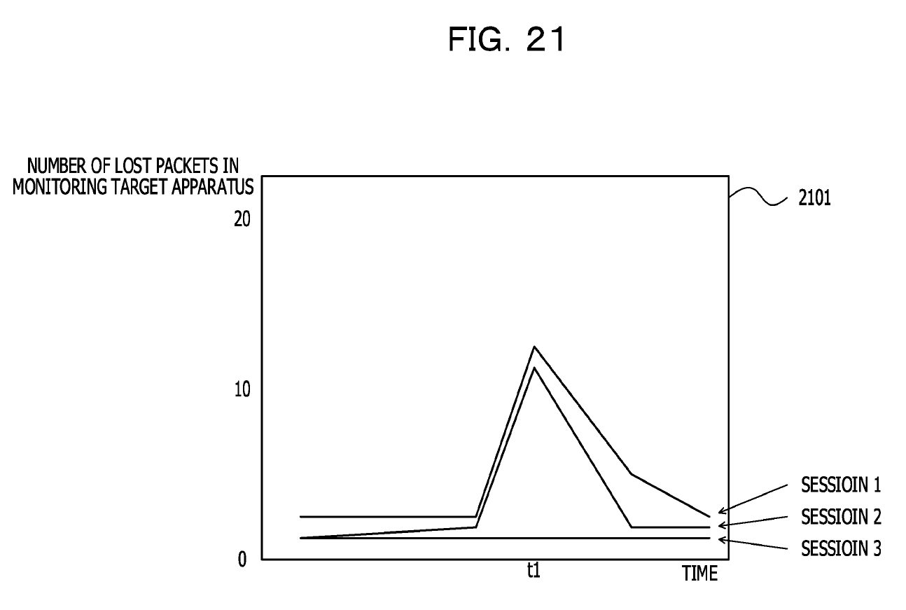

FIG. 21 is an explanatory view illustrating an example of outputting of a packet loss decision process. A graph 2101 depicted in FIG. 21 indicates the number of lost packets in the monitoring target apparatus 102 for every use period. The axis of abscissa of the graph 2101 indicates time. The axis of ordinate of the graph 2101 indicates the number of lost packets in the monitoring target apparatus 102. It is assumed that sessions 1 to 3 indicated by the graph 2101 are transmitted using the same port.

As indicated by the graph 2101, within a use period t1, the number of lost packets is 10 or more with regard to the session 1 and the session 2. Accordingly, it may be recognized that the processing performance of the port used by the sessions 1 and 2 is exceeded in the proximity of the use period t1 and packet loss occurs. In this manner, by performing management in a unit of a session, the packet verification apparatus 101 may specify a communication situation or a manner of loss of a different session for which the same transmission port is used with that of a certain session.

As described above, the packet verification apparatus 101 sets a bit of a management bit sequence on the reception side within a certain period corresponding to any bit of “1” of a management bit sequence on the transmission side within the same period to “0” and sets any bit of a packet transmitted within a next period from among the remaining bits to “0.” Consequently, the packet verification apparatus 101 may specify packet loss accurately. Further, by specifying the IPID of the lost packet, where the IPID increases sequentially, the packet verification apparatus 101 may indicate in what manner packet loss occurs. For example, if IPIDs of lost packets succeed, packets received by the monitoring target apparatus 102 increase in burst, and a buffer or the like for temporarily storing packets in the monitoring target apparatus 102 overflows, from which it may be recognized that packets are lost successively.

Further, as the second working example for packet loss decision, the packet verification apparatus 101 may set bits of a bit sequence or sequences on the transmission side within the second period corresponding to the packets of the first packet group to “0.” Consequently, even in a packet loss process in the second or succeeding cycle, the packet verification apparatus 101 may specify packet loss accurately.

Here, an example in which packet loss is decided in error in the packet loss decision process in the second or succeeding cycle in the first working example of packet loss decision is described with reference to FIG. 7. As indicated by (2) of FIG. 7, since the management bit sequence S-2 [3], [5], and [6] is “1,” the packet verification apparatus 101 sets the management bit sequence R-1 [3] and [5] to “0.” Accordingly, the packet corresponding to the management bit sequence S-2 [3] and [5] is a packet received within the period of the management bit sequence R-1. However, in the packet loss decision of the management bit sequence R-2, as a result of comparison between the management bit sequences R-2 and S-2, the packet verification apparatus 101 decides that the management bit sequence R-2 [3] and [5] is a packet received within the period of the management bit sequence R-2. In this manner, in the working example 1, a bit decided as “1” in a management bit sequence on the transmission side is sometimes used twice in the packet loss decision process in the second or succeeding cycle, and in this case, there is the possibility that erroneous decision may be made.

In contrast, in the second working example of packet loss decision, any bit used once in a management bit sequence on the transmission side is set to “0.” In the example of FIG. 7, since the management bit sequence S-2 [3] and [5] is set to “0,” the packet verification apparatus 101 may decide packet loss accurately also in the packet loss decision process in the second or succeeding cycle. In this manner, the packet verification apparatus 101 may improve the decision accuracy of packet loss in comparison with the first working example of packet loss decision by executing the second working example of packet loss decision.

Further, as the third working example of packet loss decision, the packet verification apparatus 101 may add, when it acquires a packet corresponding to a bit that already is “1” in the management bit sequence, the corresponding management bit sequence. This makes it possible for the packet verification apparatus 101 to decide packet loss accurately even in a case where the IPID varies at random and the IPIDs may overlap with each other within a use period. Further, even where the IPID increases sequentially, where only one connection occupies a reception side port or a transmission side port of the monitoring target apparatus 102, there is the possibility that, within a use period, the IPID may make one round and packets having a same IPID may be received or transmitted. Even in such a case, the packet verification apparatus 101 may decide packet loss accurately by performing the third working example of the packet loss decision.

Further, the packet verification apparatus 101 may determine to what extent a management bit sequence on the transmission side is to be used based on a maximum delay period of the monitoring target apparatus 102. Consequently, even where the maximum delay period is longer than the use period, the packet verification apparatus 101 may decide packet loss accurately.

Further, the packet verification apparatus 101 may decide packet loss for each session. This makes it possible for the packet verification apparatus 101 to find a communication situation or a manner of loss of other sessions for which a same transmission port of the monitoring target apparatus 102 is used.

Further, the packet verification apparatus 101 may count the number of lost packets for each session. This makes it possible for the packet verification apparatus 101 to readily compare packet loss in a plurality of respective sessions for which a same transmission port of the monitoring target apparatus 102 is used within the same use period.

It is to be noted that the packet verification method described in connection with the present embodiment may be implemented by a computer such as a personal computer or a work station executing a program prepared in advance. The present packet verification program is recorded into a computer-readable recording medium such as a hard disk, a flexible disk, a compact disc-read only memory (CD-ROM), or a digital versatile disk (DVD) and is executed by being read out from the recording medium by a computer. Further, the present packet verification program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory; and
a processor coupled to the memory and the processor configure to:
monitor packets received from a communication apparatus and packets transmitted from the communication apparatus; and
make a determination that a packet is lost in the communication apparatus by detecting that the packet is received by the communication apparatus within a first time period and not transmitted from the communication apparatus within a second time period, an end of the second time period being set to later in time than an end of the first time period.

2. The apparatus of claim 1, wherein
the end of the second period is determined based on a maximum delay time of processing the packets in the communication apparatus.

3. The apparatus of claim 1, wherein
the first time period corresponds to a first cycle,
the second time period includes the first cycle and at least part of a second cycle immediately following the first cycle, and
the first cycle and the second cycle have a same length.

4. The apparatus of claim 3, wherein
a first packet is not used for the determination for packets received within the second cycle when the first packet is received within the first cycle and transmitted within the second cycle.

5. The apparatus of claim 3, wherein the circuitry is configured to:
generate a reception bitmap for each cycle indicating each packet received by the communication apparatus during each cycle; and
generate a transmission bitmap for each cycle indicating each packet transmitted by the communication apparatus during each cycle.

6. The apparatus of claim 5, wherein
the circuitry is configured to generate another reception bitmap for a specified cycle when a plurality of packets identified to be the same are received within the specified cycle.

7. The apparatus of claim 5, wherein
the circuitry is configured to generate another transmission bitmap for a specified cycle upon identifying a plurality of packets received by the relay apparatus that are identified to be the same for the specified cycle.

8. The apparatus of claim 1, wherein
the packets are Internet Protocol (IP) packets,
each of the packets is identified based on information included in the packets, and
the information includes an IP identifier (IPID) included in an IP header of each packet.

9. The apparatus of claim 8, wherein
the information included in the IP header includes a source IP address, a destination IP address, and an identification of an upper layer protocol.

10. The apparatus of claim 9, wherein
the upper layer protocol is one of Transmission Control Protocol (TCP) and User Datagram Protocol (UDP), and
the information includes source TCP or UDP ports, and destination TCP or UDP ports in TCP or UDP headers of the packets.

11. The apparatus of claim 1, wherein
the communication apparatus is one of a hub, bridge, switch or router.

12. A method comprising:
monitoring packets received from a communication apparatus and packets transmitted from the communication apparatus; and
making a determination that a packet is lost in the communication apparatus by detecting that the packet is received by the communication apparatus within a first time period and not transmitted from the communication apparatus within a second time period, an end of the second time period being set to later in time than an end of the first time period.

13. A non-transitory computer-readable medium including computer program instructions, which when executed by an information processing apparatus, cause the information processing apparatus to:
monitor packets received from a communication apparatus and packets transmitted from the communication apparatus; and
make a determination that a packet is lost in the communication apparatus by detecting that the packet is received by the communication apparatus within a first time period and not transmitted from the communication apparatus within a second time period, an end of the second time period being set to later in time than an end of the first time period.
